(19) United States
(12) Patent Application Publication
(10) Pub. No.: US 2013/0013767 A1
(43) Pub. Date: Jan. 10, 2013

(54) SYSTEM AND METHOD FOR MANAGING SOFTWARE PROVIDED AS CLOUD SERVICE

(75) Inventors: Thomas Stober, Boeblingen (DE); Uwe Hansmann, Boeblingen (DE); Michael Behrendt, Boeblingen (DE)

(73) Assignee: INTERNATIONAL BUSINESS MACHINES CORPORATION, Armonk, NY (US)

(21) Appl. No.: 13/523,295

(22) Filed: Jun. 14, 2012

(30) Foreign Application Priority Data
Jul. 5, 2011 (EP) 11172754.1

(51) Int. Cl. G06F 15/173; G06F 9/44

(52) U.S. Cl. 709/224; 709/223

(57) ABSTRACT

Provided is a system and method for managing software provided as a cloud service. At least one service provider cloud provides an operating environment for one or more software instances; The software instances are in communication with to a management agent module at the at least one service provider cloud. A software instance of the one or more software instances provides a cloud service to a processing device constructed and arranged as a service consumer device. A software management module manages the software instance. The management agent module sends status information of the software instance to the software management module via a network. The software management module sends control information to the management agent module, which processes the control data, permitting the software management module to control the software instance.

### FIELD OF THE INVENTION

The present inventive concepts relate to the field of software management, and more particularly to systems and methods for managing software provided via a cloud service to one or more service consumers.

### BACKGROUND

Information technology (IT) capabilities, e.g., software and services, have historically been provided to customers directly by a creator or vendor. Applications for managing the distributed software have been typically based on the direct interaction of two parties: the software creator or vendor on the one hand and the software consumer on the other hand.

### BRIEF SUMMARY

In one aspect, provided is a computer-implemented method, comprising: providing at least one service provider cloud, each service provider cloud providing an operating environment for one or more software instances; establishing a communication between the one or more software instances and a management agent module at the at least one service provider cloud; providing a software instance of the one or more software instances as a cloud service to at least one processing device constructed and arranged as a service consumer device; managing, by a software management module, the software instance, wherein the software management module comprises a registry; sending, from the management agent module to the software management module via a network, status information of the software instance to the software management module; sending, from the software management module to the management agent module, control information; and processing, by the management agent module, the control data, permitting the software management module to control the software instance.

In another aspect, provided is a cloud service system, comprising: at least one service provider cloud that provides software to service consumers, the at least one service provider cloud including a management agent module to which a software instance of the software running at the at least one service provider cloud is in communication, the at least one service provider cloud including a plurality of interconnected computing devices; and a management computing system comprising a software management module that manages the software instance at the at least one service provider cloud, wherein: the management agent module sends software instance status information to the software management module for processing by the software management module, the software management module sends control data to the management agent module in communication with the software instance, and the management agent module processes the control data, permitting the software management module to control the software instance.

In another aspect, provided is a computer program product of a service provider cloud, comprising: a computer readable storage medium having computer readable program code embodied therewith. The computer readable program code comprises computer readable program code configured to provide one or more software instances operatively coupled to a management agent module; computer readable program code configured to permit a management computing system to at least one of monitor and control the one or more software instances; computer readable program code configured to provide the one or more software instances to service consumers according to an Anything as a Service (XaaS) model; computer readable program code configured to send, from the management agent module to the software management module via a network, status information of a software instance of the one or more software instances to the software management module; computer readable program code configured to receive, by the management agent module from the software management module, control information; and computer readable program code configured to process, by the management agent module, the control data, permitting the software management module to control the software instance.

In another aspect, provided is a computer program product of a management computing system in communication with a service provider cloud, comprising a computer readable storage medium having computer readable program code embodied therewith. The computer readable program code comprises computer readable program code configured to at least one of monitor and control one or more software instances running on at least one service provider cloud and being provided to service consumers according to the Anything as a Service (XaaS) model; computer readable program code configured to connect the management computing system to the at least one service provider cloud via a network; computer readable program code configured to provide a software management module for managing the one or more software instances, and for communicating, over the network, with a management agent module at the at least one service provide cloud in communication with the one or more software instances; computer readable program code configured to provide a registry at the software management module, the registry comprising an indication of the one or more software instances and an indication of the at least one service provider cloud acting as a runtime environment, the software management module managing all software instances of the at least one service provider cloud indicated in the registry; computer readable program code configured to receive status information sent from the management agent module in communication with a software instance of the one or more software instances, the status information being indicative of at least one of usage data and functionalities of the software instance used or requested by the at least one service consumer; computer readable program code configured to monitor, at the software management module, the software instance of the one or more software instances; and computer readable program code configured to send control data to the management agent module operatively coupled to the software instance of the one or more software instances for controlling the software instance, wherein the control data affects the functionalities of the software instance provided to the at least one service consumer.

### BRIEF DESCRIPTION OF THE SEVERAL VIEWS OF THE DRAWINGS

The above and other items, features and advantages of the invention will be better understood by reading the following more particular description of embodiments of the invention in conjunction with the figures wherein:

FIG. 1 is a flow chart of a method for managing software, in accordance with an embodiment;

FIG. 2 is a block diagram of two clouds providing software instances managed by a software management module to three service consumers, in accordance with an embodiment;

FIG. 3 is a flowchart of a method for managing software, in accordance with another embodiment;

FIG. 4 is an illustration of an overview of a system architecture of a distributed computer system according to one further embodiment of the invention; and

FIG. 5 is a detailed diagram of a service provider cloud.

### DETAILED DESCRIPTION

Modern IT-capabilities permit music files, video films, software applications or certain functionalities thereof, to be provided to end-users by means of cloud services. The vendor of such applications or services, in this scenario, typically does not provide his software to the consumer directly by applying a traditional software licensing model, but rather deploys his software to cloud service platforms provided and operated by a third party, herein called a ‘cloud service provider’. The cloud service provider operates one or more clouds, thereby providing for a technical platform allowing a plurality of end-users or ‘service consumers’ to request and use a particular IT-capacity according to the “Anything as a Service” (XaaS) model. Server-side applications, such as those offered by the GoGrid hosting service, provide for a cloud hosting infrastructure, which also assists in the billing of customers. Central license servers, e.g., the Tivoli license manager, or a system described in U.S. Patent Application Publication No. 20090037337 A1, incorporated herein by reference in its entirety, provide for a central software licensing and enforcement system which is operable to communicate with a plurality of software products having been installed at a customer site, thereby ensuring that a customer using such software still has a valid license.

In comparison to the Tivoli license manager, a digital rights management server disclosed in U.S. Patent Application Publication No. 20080091613 A1, incorporated herein by reference in its entirety, ensures that a customer using a particular piece of data, e.g. a piece of music, a video or the like, has a valid license.

For the vendor, using a service provider is advantageous as he does not have to operate a cloud-environment on his own. A disadvantage is, however, that the vendor loses direct technical control of his software. Current software management systems cannot be used by a software vendor for maintaining technical control of his software once the vendor has distributed his software to the service providers. Accordingly, there is a need for improved software management solutions which can also be used in a cloud-environment based usage scenario.

In one aspect, embodiments of the invention address and resolve the problem of providing an improved method for remotely managing software running on one or more cloud service environments, wherein the software is provided to one or more service consumers.

A ‘cloud’ as used herein includes a pool of interconnected computing resources, e.g., networks, servers, storage, applications, and services, that are provided via one or more cloud services to service consumers in accordance with the five essential characteristics specified by the National Institute of Standards and Technology (NIST), i.e., support and provide for ‘on-demand self-service’, ‘broad network access’, ‘resource pooling’, ‘rapid elasticity’ and ‘measured service’. In a cloud computing environment, a service provider may offer services to one or more service consumers. The services can include the use of one or more instances of the software having been installed in the cloud computing environment. These services can include the use of software applications installed in the cloud. A ‘service provider cloud’ is a cloud computing environment which acts as runtime environment of one or more instances of a software being provided by the vendor according to an XaaS or related model. A service provider is the operator of such a cloud. In many cases, service agreements between the cloud service provider and an operator of a cloud service consumer exists and the cloud services may be provided based on the service agreement.

A ‘cloud service’ as used herein is any kind of service being in accordance with the XaaS service model and providing IT capabilities of the cloud to one or more service consumers. According to the XaaS model, the IT capability provided to the consumer is to use the provider's offerings running on a particular service provider cloud. The IT-capability, e.g. a software application, is typically accessible from various client devices through a thin client interface such as a web browser (e.g., web-based email).

A ‘software vendor’ is an entity having developed or issued a particular IT-capability. A software vendor may issue patches and updates for his software from time to time and may, according to some embodiments, have a contract or other form of license agreement with one or more service providers hosting his software. A service provider is an operator of one or more clouds. A service provider may have license agreements with one or more operators of service consumers. In other embodiments there may be a direct license/usage agreement between the consumer and the vendor, facilitated by the provider. A service consumer is a processing system operated by a person or company having a software license agreement with the service provider, whereby the service consumer is operable to use an instance of the software technically provided by a service provider according to the XaaS or related model.

A ‘registry’ is any kind of data structure comprising a list of data entries. A registry can be, for example, a file, e.g. an XML file, one or more tables of a relational database, or the like. A ‘rule’ is a computer interpretable set of instructions comprising one or more conditions connected by one or more Boolean operators.

An ‘aspect’ is a software-module that encapsulates a concern. An aspect is typically composed of pointcuts, advice bodies and inter-type declarations. In some approaches, an aspect may also contain classes and methods. An aspect may be used for introducing new functionalities to a piece of software without recompiling the software. An aspect can be written, e.g., in the programming language AspectJ.

A ‘computer readable storage medium’ may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages.

In one aspect, the invention relates to a computer-implemented method for managing software. The software is provided to service consumers by one or more service provider clouds according to an XaaS or related model. The method enables a management computing system not being one of the service provider clouds to monitor and/or control instances of the software running on the service provider clouds. The method comprises: providing the one or more service provider clouds, each service provider cloud being a pool of interconnected computing resources and acting as runtime environment of one or more instances of the software, each software instance being operatively coupled to a management agent module; providing at least one of the software instances as part of a cloud service to at least one processing device acting as service consumer;providing a software management module for managing the one or more software instances, the software management module running on the management computing system connected to each of the service provider clouds via a network. The software management module is operable to communicate, over the network, with the management agent module operatively coupled to each software instance, the software management module comprising a registry, the registry comprising an indication of the one or more software instances and an indication of the one or more service provider clouds respectively acting as runtime environment. The software management module manages all software instances of the one or more service provider clouds indicated in the registry; sending, by the management agent module operatively coupled to the at least one software instance, status information of the software instance via the network to the software management module, the status information being indicative of usage data and/or functionalities of the software instance used or requested by the at least one service consumer, thereby enabling the software management module to monitor the software instance, and receiving, by the software management module, the status information; and/or sending, by the software management module, control data to the management agent module operatively coupled to the at least one software instance for controlling the software instance, and receiving and processing, by the management agent module operatively coupled to the software instance, the control data. Therefore, the software management system is enabled to control the software instance, as the control data affects the usage data and/or functionalities of the software instance provided to the at least one service consumer.

Providing a software instance via a cloud service as used herein means that the software instance can be made accessible to a service consumer via a cloud service. The term ‘software’ as used herein relates to a set of program instructions and/or data of a particular type. The term ‘software’ may relate to a particular kind of application program, a particular VM image or the like. In other words, the term ‘software’ should be considered as a synonym to the expression ‘software type’. A software instance would be an instance of the particular type of software, e.g. an instance of a particular type of application program or a copy of a particular VM image. Each cloud service can provide one or more software instances to a service consumer. A ‘functionality’ as used herein encompasses any function or feature provided by a piece of software to other routines of the software, to other software applications or to a user of the software. A functionality may be a computer-implemented method or routine, one or more data values, graphical user interface elements, audio- or image files or the like. At least some functionality may be dynamically and/or upon instantiation of the software enabled or disabled.

Depending on the embodiment, for each management agent module running on a particular cloud there may exists one single software instance or a plurality of software instances in respect to one particular software. For example, the management agent module may be provided as a plug-in of the software, whereby the plug-in is instantiated within a cloud environment only once. Each software instance is operable to communicate with the single management agent module instance and the single management agent module instance is operable to manage the communication between the remote software management module and a plurality of different instances of the particular software within a particular service provider cloud. According to other embodiments, each software instance may comprise or be operatively coupled to one individual management agent module instance. Each embodiment described in the following which is based on one management agent instance per software instance can also be implemented based on a 1:n relation of 1 management agent module and n software instances of one software type on one particular service provider cloud.

‘Metering’ the software instance comprises receiving, from the software instance, any data which can be used for tracking and maintaining software licenses, for detecting unregistered or unlicensed software instances, for tracking the identity and/or location of a user, and for evaluating the type of functionalities of the software instance actually used. In addition, or alternatively, metering the software instance may comprise receiving data which can be used for evaluating the time and duration a particular software feature or function of the software instance was used by a particular user. The term ‘monitoring’ a software instance as typically used in the art comprises, for example, receiving data being indicative of the availability of a software instance and/or receiving data which may help ensuring the availability of the software instance. Monitoring a software instance may comprise receiving information regarding the location from which a software instance is requested, regarding context parameters, regarding the system and/or error state of the software instance and the like. Although the term ‘monitoring’, according to its typical use in the art is different from ‘metering’ the usage of a software, the term ‘monitoring’ as used herein will for the sake of simplicity also subsume the concept of ‘metering’. Thus, the expression ‘monitoring’ as used herein encompasses receiving, from the software instance, any kind of information which can be used for the purposes of metering and/or software monitoring. The status information may accordingly be of any complexity, ranging from simple error codes to complex data objects. It may comprise plain text documents, binary data formats, or the like.

The features in accordance with embodiments herein are advantageous, as they may allow a software vendor operating the management computing system and the management module to remotely manage software that is offered to customers on a plurality of different service provider clouds. For example, a vendor may receive status information being indicative of the usage frequency of particular software functionalities, of error messages and the like. The vendor may use this information for improving his software. The vendor may also submit control data to deactivate his software, thereby ensuring that outdated versions are no longer distributed. The vendor may be enabled to deactivate or enable particular program functions, to modify user data, e.g., adapt user-specific configuration settings in accordance with the requirements of a new software version, and the like. Since the management module directly interacts with the individual management agent modules of the software, the vendor does not have to rely on the trustworthiness of the service providers. If a service provider tries to distribute outdated program versions, the vendor is enabled to remotely deactivate the software versions or particular software functions. Likewise, in the event that a fraudulent service provider should provide the vendor's software to one thousand service consumers but only notify the vendor of five hundred service consumers, the vendor is protected against this fraud, as he receives status information from each of the requested software instances directly. Accordingly, the vendor as the operator of the software management module does not have to maintain the hardware infrastructure for providing his software to the end-users but never the less stays in control of his software. According to some embodiments, each service consumer connected to a particular service provider cloud triggers the instantiation of one or more instances for each requested type of software, each instance being provided via one particular cloud service.

In another aspect, embodiments of the invention are advantageous as the operator(s) of the cloud services may not have to care about licensing issues when providing a vendor's software to a plurality of different clients. This is advantageous, because the validity of using a software depends on the individual license agreement between an end-user and the vendor. The validity of using a software may alternatively, or in addition, depend on a service agreement between the end-user and a service provider. In the following usage agreements between a vendor and an end-user operating the service consumer devices and service agreements between a service provider and an end-user operating the service consumer devices will be subsumed as ‘license agreement’. In addition, a contract between an operator of a service consumer and the software vendor may exist. For at least some embodiments, the contract is also be subsumed by the term ‘license agreement’. Checking the validity of a license of a requested software instance can be, according to embodiments of the invention, fully atomized and kept under the control of the vendor. This significantly reduces the workload of the operators of the one or more clouds. The vendor may work with different hosting providers in parallel, thereby making use of a variety of different levels of quality of service, different hardware backbones, while still in keeping full control of his software.

Embodiments of the invention are advantageous, because a plurality of different service provider clouds may be used, thereby reducing the processing load of different sub-clouds and providing for a faster and/or more reliable service compared to the use of only one single service provider cloud. In addition, the embodiments of the invention allow a vendor to remotely control if and how many software instances are provided by each of a plurality of different service provider clouds, as the vendor may submit control data deactivating a software instance in case a software provider provides for more software instances than the vendor and the operator of the service provider cloud agreed upon. Embodiments of the invention enable the vendor to dynamically decide via which service provider cloud(s) his software is provided to the consumers and to flexibly enable and/or disable service provision via a particular provider based on criteria such as service quality, bandwidth, price or the like.

According to embodiments, each service provider cloud comprises or is operatively connected with a service-provider configuration module (SPCM). The software management module is operable to communicate with each of the SPCMs via the network. Each SPCM comprises one or more configurations. A configuration can, for example, be a configuration file or configuration entry in a database. Each configuration determines, for a software provided by the corresponding service provider cloud, which functionalities of the software should be enabled.

According to some embodiments, the management agent module is implemented as a plug-in of the software instance, as in integral part of the source code of the software and/or as an aspect added to the software without any recompilation. According to some further embodiments, the management agent module may also be implemented as a piece of software being instantiated only once for each individual software type and for each individual service provider cloud, the single management agent module instance being operatively coupled to a plurality of different instances of the individual software type. According to other embodiments, the management agent module may also be implemented as software instantiated only once for each service provider cloud. Here, the single instance may be operatively coupled to instances of a plurality of different software types provided, for example, by the same vendor. Depending on the embodiment, the software management module can be implemented in software, hardware, and/or firmware-based logic, or a combination thereof, the logic being operable to communicate via a network to management agent components of software programs which are physically hosted on a plurality of different service provider clouds for managing access to the software instances and/or managing the functionalities of the software instances provided to each particular service consumer.

According to some embodiments, a registry is dynamically updated and keeps track of all software instances initiated at each service provider cloud. It may also keep track of all functionalities provided by each of the initiated software instances to a particular consumer. An entry of the registry may comprise the information that a 1st instance of software application A is running on cloud C1, a 2nd instance of software application A is running on cloud C2 and that an additional instance of software application B is operated on cloud C2. According to some embodiments, the entries of the registry may in addition comprise information being indicative of the name and address of an end-user having a license agreement for a software in respect to the vendor and/or individual service providers. Depending on the embodiment, the software management module can be run on any computing system being connected to the one or more service provider clouds via a network, e.g. a single server operating an application server or a set of computing resources together forming a further cloud, herein also referred to as ‘super-cloud’. The super-cloud is a pool of further interconnected computing resources and acts as runtime environment of an instance of the software management module. The software management module is provided to processing devices of one or more different vendors via a cloud service in accordance with the XaaS model. Using a super-cloud is advantageous, because a plurality of different vendors may use the same software management instance for managing their software.

According to some embodiments, the functionalities controlled can be, for example, a cryptographic algorithm for encrypting and/or decrypting data, a particular function of an application program to be activated or deactivated, a particular set of templates, e.g. stencils, used by an application program, and the like. The software instance provided via a cloud service may be any kind of application program, e.g. programs for controlling industry manufacturing processes, office applications, applications for performing business-related tasks and the like. ‘Status information’ of a software instance can be, for example, an identifier of a feature or a function of the software requested or used by a service consumer, the location of the service consumer, e.g. a particular country, the moment in time when the service consumer requests or executes a particular function, context data, user data or user input of the consumed software instance, and the like.

According to further embodiments, the software management module further comprises an update module. The update module is operable to execute a software-based and/or a software instance-based update of the software. Executing the software instance-based update comprises sending software updates to the one or more software instances during runtime of the software instances. Thereby, the update module modifies, adds and/or removes one or more functionalities of the software instance via the management agent module operatively coupled to the respective software instance. Executing the software-based update comprises sending updated binary instructions of the software to a service provider configuration module of the service provider cloud providing the software to be updated, the service provider configuration module being operable to instantiate the software by instantiating the updated binary instructions. The features are advantageous, because the operator of the service provider cloud may not have to keep the provided software up to date. Rather, the vendor may use the update module of the software management module to automatically propagate any updates and/or program patches to a plurality of different service provider clouds for all instances of a particular software currently running on the cloud (if the per-software-instance update is executed) and/or for all instances to be instantiated in the future (if the per-software update is executed). The features may further be advantageous, because the software management module is operable to update a plurality of software instances by means of a push method, thereby updating all software instances in parallel at the same time. Depending on the embodiment, executing an update by the update module may be triggered by a user action on the software management module and/or may be triggered according to a predefined execution schema, e.g. according to a cron job or the like. Updates may be executed based on the information contained in the registry on a per-service provider cloud basis or even on a per-service consumer basis. Embodiments of the update module supporting a per-software update are based on a registry comprising a mapping of each software of a vendor to one or more service provider clouds providing instances of the software to service consumers. Embodiments of the update module supporting a per-software-instance update are based on a registry comprising a mapping of each software instance of each software of a vendor to one or more service provider clouds providing the software instances to the service consumers. The mapping may be based on one or more management agent modules running of a particular cloud and being operatively connected to one or more software instances.

According to other embodiments, the at least one software instance is operable to execute one or more callback functions, each callback function being executed when the software instance is requested by at least one of the service consumers, when a particular function of the software instance is called, and/or when the usage of the software is terminated. The features are advantageous, because the callback method may, for example, comprise a request for receiving updates or patches being meanwhile available at the side of the software management module. The callback method may comprise information on the location, e.g. the country, from which the service consumer has requested the software instance, and/or information on the user of the service consumer device. The callback function may also be used to submit the status information to the software management module via the management agent module operatively coupled to each software instance. As a consequence, e.g. upon initiating a particular software instance for the user, or when the user uses a particular function of the initiated software, the identity of the user, user data or other information can be submitted together via the request to the software management module. The software management module may thereby be provided with statistical data on the time and/or frequency the user uses a particular software or a particular feature or function of the software. The callback function may use program routines of the respective management agent module for submitting data to the software management module.

According to other embodiments, the software management module is operable to execute one or more remote access functions. A software instance may execute one of the callback functions, the executed callback function automatically submitting a request for executing at least one of the remote access functions to the software management module. The receipt of the request by the software management module then triggers the execution of the requested remote access function. The features are advantageous, because they may provide for an automated means of interaction between the individual software instances and the software management module. The features may also be advantageous, because by executing remote access functions requested by a callback method, the task of providing updates or patches to the software instances can be implemented by means of a pull method, e.g. when a particular software instance is initiated, thereby reducing the network traffic required for propagating the updates to all software instances at a particular moment in time.

According to some embodiments, the execution of a remote access function may comprise activating and/or deactivating a functionality of the software instance having submitted the request on a per-software instance basis. In addition or alternatively, executing a remote access function may comprise deploying a software-patch and/or an update for the software on a per-software basis. This may not affect the existing software instances but may rather affect the configuration evaluated when instantiating the software. For example, the software-patch and/or update may be deployed to a particular service provider cloud based on the mapping of software and service provider cloud stored in the registry of the software management module. An updated configuration of a particular software may be distributed by a vendor to all service provider clouds running the software according to the mapping. The execution of a remote access function may also comprise executing the software-based update step. For example, this may imply deploying a software-patch and/or an update in the form of binaries to a SPCM-registry of a service provider configuration module of a particular service provider cloud. Executing a remote access function may also comprise executing the software-instance based update step, thereby updating the software instance having submitted the request. For example, this can be done by injecting new functionalities by means of AspectJ programming to instances of the software at runtime. Executing a remote access function may also comprise analyzing, by an analytical module of the software management module, data having been submitted in the request and/or having been submitted in a set of previous requests to the software management module. The data may be, for example, status information sent previously by one or more management agent modules to the software management module. A remote access function may also comprise logging the received status information and/or the functionalities executed by the calling software instance. According to some embodiments, the log may be used by the analytical module for metering the usage of the software instance.

According to other embodiments, the software management module is operable to enable and/or disable functionalities of the software on a per-software basis and/or on a per-software-instance basis, Enabling and/or disabling functionalities of the software on a per-software-instance basis comprises the following steps to be executed by the software management module: identifying, by means of the registry of the software management module, one or more service provider clouds providing a particular software; identifying one or more management agent modules being operatively coupled to software instances of the particular software, the software instances currently running on the identified service provider clouds; determining one or more functionalities of the software which should be enabled or disabled. For example, this determination may be made automatically by a rules engine evaluating status information received from one or more software instances, based on license agreement information made available to a license management module or the like. According to embodiments this determination may be also based on user input received via a GUI of the software management module. Then, an indication of the functionalities which shall be enabled and/or disabled is sent by the software management module to the identified one or more management agent modules. Since the sent indication is used by the identified management agent modules for controlling the functionalities of software instances, the indication can be in a form of the ‘control data’. Control data can be submitted e.g. in the form of an XML file, as BLOB, as property-value list or the like. Upon having received the sent indication, the identified one or more management agent modules enable and/or disable the indicated functionalities of their operatively coupled software instances. Enabling and/or disabling functionalities of the software on a per-software basis comprises the following steps to be executed by the software management module: identifying, by means of the registry of the software management module, one or more service provider clouds providing the software; determining one or more functionalities of the software which should be enabled or disabled; transferring a configuration of the software to each service provider configuration module (SPCM) of the identified service provider clouds, the configuration comprising an indication of the determined functionalities to be enabled and/or disabled. A service provider configuration module installed on each of the identified service provider clouds instantiates the software in accordance with the configuration specifying the functionalities to be enabled and disabled. Accordingly, the software instances currently running on a particular cloud may not be affected by the modified configuration which is preferentially stored to a SPCM-registry of the SPCM, depending on the control data sent by the software management module. The SPCM is operable to instantiate a new instance of a software, the instantiation being based on the configuration and, according to some embodiments, also on the binaries of the software stored in the SPCM-registry of the SPCM. Any modification of the configuration of the SPCM-registry may affect the functionalities enabled in each software instance created in accordance with the modified configuration. Any update to the binaries of a particular software may cause the SPCM to instantiate updated versions of the software. For identifying the service provider clouds the software management module accesses the registry comprising identifiers of the service provider clouds hosting a particular software and/or particular instances of the software. Further, in the registry license agreements, configurations for various kinds of software and/or a list of configurable functionalities for a particular software may be stored. The determination of the functionalities to be enabled and/or disabled may be calculated, for example, on a per-software, per service provider cloud, per service consumer or per-location-of-service consumer basis.

According to other embodiments, the update module is operable to inject, for executing the software instance-based update, at least one new software function into the at least one software instance over the network via the management agent module operatively coupled to the software instance. According to some of the embodiments, the injection is executed during runtime of the software instance and the injected software function becomes functional without any recompilation of the source code of the at least on e software instance. This may be advantageous, because they may provide for a highly flexible software architecture and may allow introducing additional program functionalities to the already deployed software instances without requiring any recompilation of the software instances.

According to other embodiments, each of the service provider clouds operates a service provider configuration module. The software management module further executes the steps of: providing, to the service provider configuration module of at least one service provider cloud, a configuration for the software whose instances are provided by the service provider cloud, the software management module comprising a copy of the configuration or having remote access to the configuration residing on the provider side, the configuration comprising one or more constraints; evaluating status information received from one or more management agent modules operatively coupled to any of the instances of the software running on the at least one service provider cloud. In case the evaluation returned as result that the received status information violates one or more of the constraints of the configuration, the software management module executes at least one of the following steps: enabling and/or disabling functionalities of the software on a per-software basis; and/or enabling and/or disabling functionalities of the software on a per-software-instance basis; and/or triggering the redirection of the at least one service consumer to another of the service provider clouds. Depending on the embodiment, evaluating whether the status information received from one or more management agent modules are indicative of the violation of one or more of the constraints may be based on remotely accessing the configuration stored in the SPCM-registry or by accessing the copy of the configuration stored e.g. in the registry or another component of the software management module. According to preferred embodiments, the one or more constraints may comprise a threshold value being indicative of the maximum admissible number of the instances of the software provided by the service provider cloud. In the embodiments, the evaluation comprises determining the number of instances of the software currently running on the at least one cloud. A ‘constraint’ as used herein may relate to any data value on which, when evaluated by the software management module, the decision whether a functionality of a software or software instance shall be disabled or enabled will depend. It may be, for example, a time period within which a software may be used. A constraint may be a whitelist or blacklist of functionalities to be enabled or disabled. A constraint may be part of a rule evaluated by the rules engine. Software components used by the at least one service consumer for requesting the instantiation of the additional software instance may be manipulated by the software management module remotely in order to trigger the redirection of the user having requested a particular software instance from a particular service provider cloud. For example, a DNS mapping which maps an IP address of a service provider to a domain may be manipulated. According to some embodiments, manipulating software components for automatically redirecting a request of a service consumer for a particular software instance comprises automatically changing a DNS mapping in a Domain Name Server (DNS) environment by the software management module. For example, a user may be allowed to request for a particular software instance via a GUI, e.g. an HTML interface, hosted by a particular service provider. The request is forwarded to a DNS service which can be accessed by the software management module. The software management module, may have detected, e.g. by evaluating one or more rules, that a particular service provider cloud already serves the maximum allowed number of software instances to service consumers. As a consequence, the software management module automatically changes the DNS mapping such that new service requests to the particular service provider clouds are automatically forwarded to a service provider cloud with a lower workload. The features are advantageous, because they may allow the software management module to automatically, at any given moment, determine if a service provider should be blocked from providing further services, e.g. to guarantee that the bandwidth or processing power provided per software instance does not fall below a minimum quality of service level. The features may allow the software management module to dynamically choose the cheapest, fastest, and/or otherwise optimal service provider and corresponding cloud platform. As a result, software may be provided to the service providers in a multitude of different ways, thereby taking into consideration the particular requirements of each service consumer, e.g. a particularly low price, a particularly reliable availability of the software and/or a particularly quick data connection.

According to other embodiments, the GUI is hosted by the vendor. The software management module may directly manipulate the GUI in dependence on the evaluation result. For example, the operator of the management computing system may provide a HTML page to his customers via the internet. A link underlying a log-in button of the HTML page which usually points to a log-in page of a first service provider cloud is automatically amended such that the link points to the log-in page of a second service provider cloud. According to still further embodiments, an already logged-in is redirected to the other service provider cloud by the software management module.

According to other embodiments, the software management module further comprises a rules engine. The rules engine is operable to evaluate one or more rules on the status information received from the management agent module operatively coupled to the at least one software instance and on the content of the registry, wherein the registry content comprises license agreements of one or more logged-in users for the at least one software instance. Then, the rules engine is operable to determine the control data in dependence on the received status information and the license information. In addition, or alternatively, the rules engine is operable to evaluate one or more rules on the status information received from the management agent module and on the content of the registry. The registry context indicates the service provider cloud running the software instance. Then, the rules engine is operable to determine the control data in dependence on the received status information and the service provider cloud. The features are advantageous, because they may provide for a much more flexibly modifiable means for managing a plurality of software instances by the software management module in dependence on the respective context. Depending on the embodiment and the respective rules used, such context may relate to the software instance consumed, the current cloud service provider, the location of the service consumer, the particular feature or function used or requested by the service consumer and/or the corresponding license agreement. A rule evaluated on a piece of data by a rules engine returns a result, e.g. a Boolean value.

According to some embodiments, a rule may comprise, for example, conditions relating to the country of the end-user using one of the software instances provided by one of the clouds. In addition some rules may comprise a specification of constraints, e.g., country-specific constraints regarding the functionality of a particular software. Upon evaluating the status information received from the at least one software instance, the rules engine may return an evaluation result. The evaluation result may in turn be used for determining control data, e.g. one or more commands for controlling the functionalities provided to the service consumer.

According to some embodiments, executable code specifying the new software function is received by the management agent module operatively coupled to the at least one software instance from the update module. The received executable code is then injected or installed into the at least one software instance for modifying, invoking, enabling and/or blocking one or more functionalities of the software instance. The features may be advantageous, because they may render any recompilation of the source code of the already deployed software instances unnecessary, thereby reducing maintenance work of the software vendor.

According to other embodiments, the software management module further comprises an analytical module, wherein the analytical module analyzes the status information gathered by the management agent module from the software instance, thereby metering the functionalities of the software instance actually used by the service consumer. Metering the functionalities of a software instance means that the usage of the functionalities is statistically evaluating. Thereby, a vendor may receive information regarding the kind of feature or function being used frequently by a particular service consumer, and may specifically adapt further releases of his software to the needs of his customers.

In another aspect, the invention relates to a computer-system for managing software provided to service consumers by one or more service provider clouds according to the XaaS model, wherein the method enables a management computing system not being one of the service provider clouds to monitor and/or control instances of the software running on the service provider clouds, the computer-system comprising: one or more service provider clouds, each service provider cloud being a pool of interconnected computing resources and acting as runtime environment of one or more instances of the software, each software instance being operatively coupled to a management agent module, whereby the one or more service provider clouds provide least one of the software instances via a cloud service to at least one consumer processing device acting as service consumer of the cloud service; the management computing system operating a software management module for managing the one or more software instances, the management computing system being connected to each of the service provider clouds via a network, the software management module being operable to communicate, over the network, with the management agent module operatively coupled to the at least one software instance, the software management module comprising a registry, the registry comprising an indication of the one or more software instances and an indication of the one or more service provider clouds respectively acting as runtime environment, the software management module managing all software instances of the one or more service provider clouds indicated in the registry. The management agent module operatively coupled to the software instance is operable to send status information of the software instance to the software management module via the network, the status information being indicative of usage data and/or functionalities of the software instance used or requested by the at least one service consumer, thereby enabling the software management module to monitor the software instance, and wherein the software management module is operable to receive the status information. In addition, or alternatively, the software management module is operable to send control data to the management agent module operatively coupled to the at least one software instance for controlling the software instance via the network, and wherein the management agent module operatively coupled to the software instance is operable to receive and process the control data, thereby enabling the software management module to control the software instance, wherein the control affects the usage data and/or functionalities of the software instance provided to the at least one service consumer.

According to some embodiments, each set of first processing devices is operable to execute the method steps of embodiments of the inventive method described above to be executed by the management agent modules of the software instances provided via a cloud service. Depending on the embodiment, the management computing system operating the software management module is operable to execute the method steps of embodiments of the inventive method described above to be executed by the software management module.

In another aspect, the invention relates to a set of one or more computer-readable, non-transitory storage media of a service provider cloud, the service provider cloud acting as runtime environment of one or more instances of a software, each software instance being operatively coupled to a management agent module, the set of one or more computer-readable storage media comprising instructions which, when executed by a processor, provide for a method for enabling a management computing system to monitor and/or control the one or more software instances, the software instances being provided to service consumers according to the XaaS model, the method comprising providing at least one of the software instances via a cloud service to a processing device acting as service consumer, sending, by the management agent module operatively coupled to the software instance, status information of the software instance to a software management module via a network, the software management module running on the management computing system connected to the service provider cloud via the network, the status information being indicative of usage data and/or functionalities of the software instance used or requested by the at least one service consumer, thereby enabling the software management module to monitor the software instance, and/or receiving and processing, by the management agent module operatively coupled to the at least one software instance, control data from the software management module via the network, wherein the control data affects the functionalities of the at least one software instance provided to the at least one service consumer.

In another aspect, the invention relates to a computer-readable, non-transitory storage medium being operatively coupled to a management computing system, the computer-readable storage medium comprising instructions which, when executed by a processor, provide for a method for monitoring and/or controlling one or more instances of a software running on one or more service provider clouds and being provided to service consumers according to the XaaS model, the management computing system being connected to each of the service provider cloud via a network, the method comprising the steps of: providing a software management module for managing the one or more software instances, the software management module being operable to communicate, over the network, with the management agent module operatively coupled to each software instance, the software management module comprising a registry, the registry comprising an indication of the one or more software instances and an indication of the one or more service provider clouds respectively acting as runtime environment, the software management module managing all software instances of the one or more service provider clouds indicated in the registry; receiving, by the software management module, the status information sent from the management agent module operatively coupled to the at least one software instance via the network, the status information being indicative of usage data and/or functionalities of the software instance used or requested by the at least one service consumer, thereby enabling the software management module to monitor the at least one software instance; and/or sending, by the software management module, control data to the management agent module operatively coupled to the at least one software instance for controlling the software instance, wherein the control data affects the functionalities of the at least one software instance provided to the at least one service consumer.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Aspects of the invention may take the form of a computer program product embodied in one or more computer readable medium(s) having computer readable instructions embodied thereon. Any combination of one or more computer readable media may be utilized.

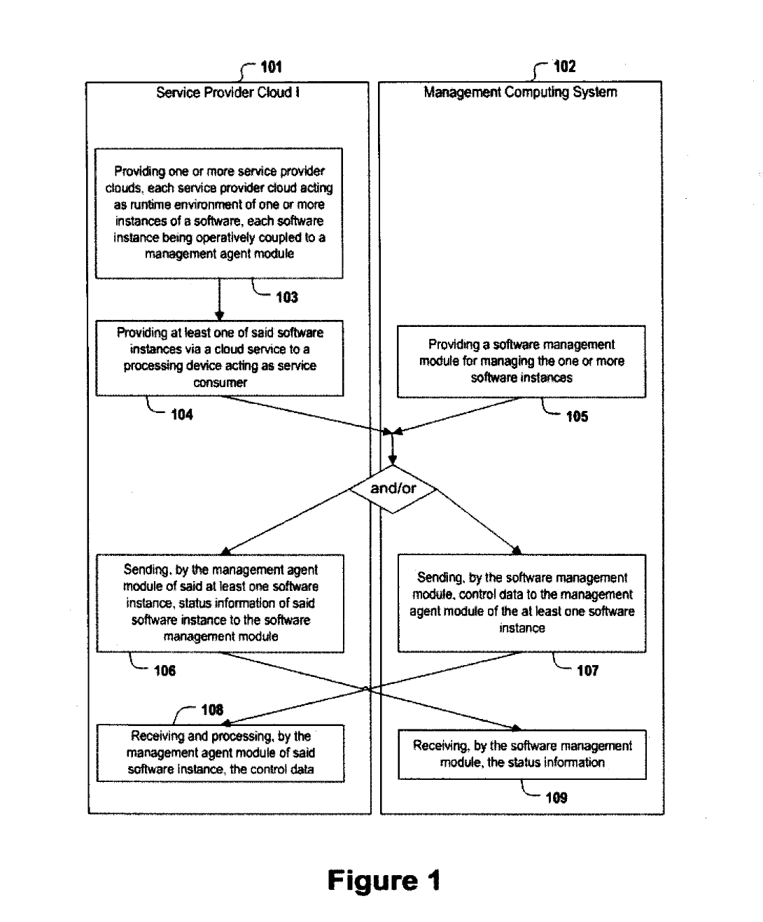

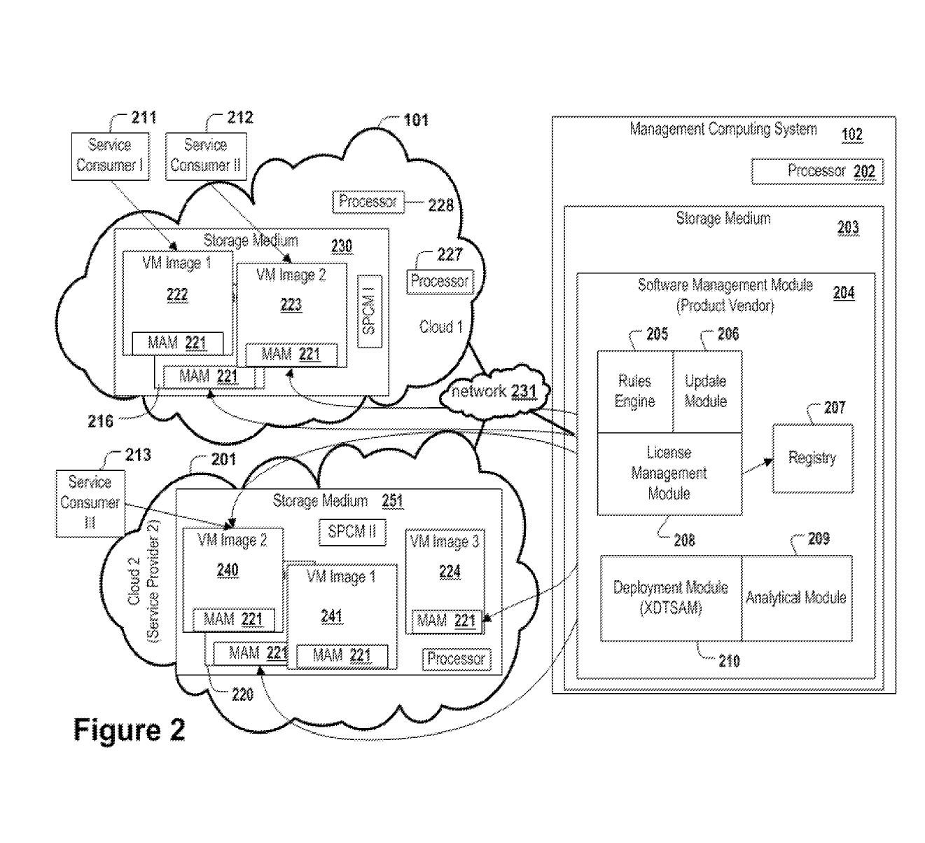

FIG. 1 is a flow chart of a method 100 for managing software, in accordance with an embodiment. The steps of the method can be executed, e.g., by components of an embodiment of the present inventive concepts as depicted in FIG. 2. FIG. 2 is a block diagram of two service provider clouds 101, 201 providing software instances managed by a software management module 204 to three service consumers 211, 212, 213, in accordance with an embodiment. The method 100 of FIG. 1 can be executed at elements of the block diagram of FIG. 2, for example, a service cloud 101 and/or a management computing system 102.

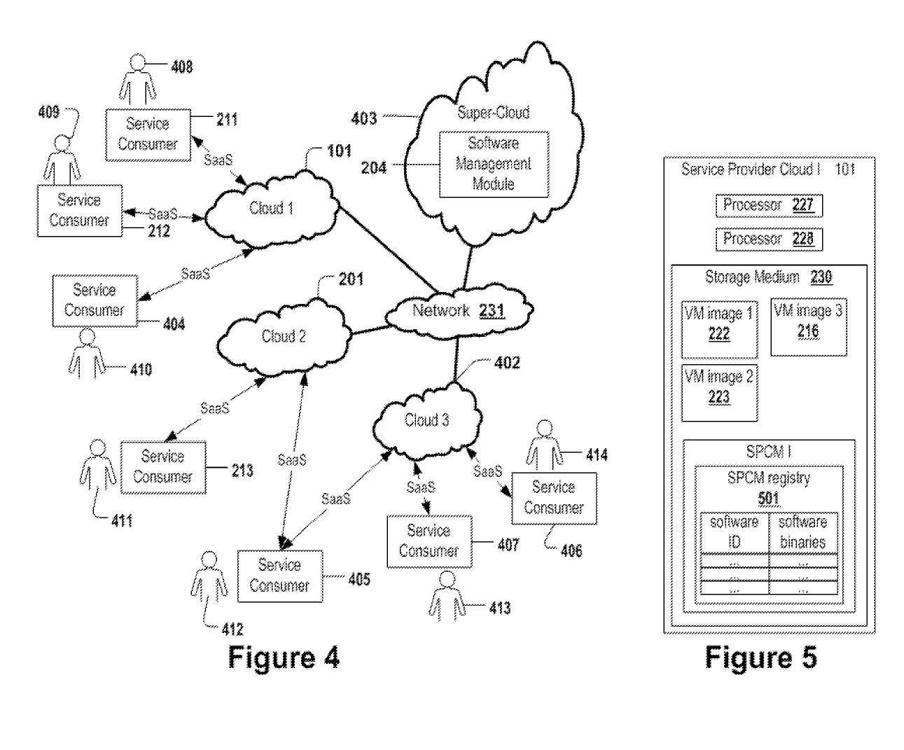

The management computing system 102 is connected to a first service provider cloud 101 and a second service provider cloud 201 via a network 231, and optionally at FIG. 4. The network 231 can be part of a public switched telephone network (PSTN), a mobile communications network, a data network, such as a local area network (LAN) or wide area network (WAN), or a combination thereof, or other communication networks known to those of ordinary skill in the art. A first consumer 211 and a second service consumer 212 can use or otherwise consume software instances 222, 223 via the network 231. A third service consumer 213 can use or otherwise consume a software instance 240 provided by the second service provider cloud 201. The first cloud 101 comprises one or more processors 227-228 which are operable to execute computer-interpretable instructions stored to a non-volatile, computer readable storage medium 230. The storage medium 230 may consist of a plurality of distributed storage media being interconnected to each other for forming a cluster of storage media for the first cloud 101. By executing the instructions, the first cloud 101 can permit the service consumers 211, 212 to have access to the software instances 216, 222 and 223. Due to space limitations, not every service consumer of a cloud service is shown. According to the depicted embodiment, the software instances provided by cloud 101 can include three different VM image instances. Each software instance can be instantiated in one or in multiple copies. The second service provider cloud 201 comprises 4 different VM image instances 220, 224, 240, 241. Each software instance comprises a management agent module (MAM) 221.

The management computing system 102 comprises a computer readable storage medium 203 which comprises computer readable instructions which can be executed by processor 202. The instructions specify a software management module 204 comprising a rules engine 205, an update module 206, a license management module 208 and a registry 207. The software management module of the management computing system is operable to exchange data with each MAM of all software instances running on clouds 101 and 201. The software management module 204 further comprises a deployment module 210 for automatically deploying the software to service providers as specified in the registry and an analytical module 209.

With reference to FIGS. 1 and 2, in step 103, the first 101 and second 201 service provider clouds are provided by a service provider. Each service provider cloud 101, 201 can provide a runtime environment having one or more software instances 216, 220, 222-223, 240, 241. Each software instance can comprise a management agent module MAM 221. In step 104, at least one of the software instances is provided to a processing device 211-212 acting as service consumer via network 231. In addition, in step 105, a data processing device which is typically operated by the vendor of the software can provide a software management module 204 for managing the one or more software instances. The software management module 204 comprises a registry 207. The registry 207 comprises data indicative of the one or more software instances. The registry 207 comprises data indicative of the one or more service provider clouds 101, 201, respectively, performing in a runtime environment. For example, the registry 207 can include the information that both the first and the second cloud respectively provide for one instance of VM image 1 222. The software management module 204 is operable to manage all software instances running on the one or more service provider clouds which are indicated in the registry. Accordingly, software instances running on that service provider clouds which are not contained in the registry 207 remain unaffected by the software management module 204. In step 106, the MAM of the at least one software instance can send status information of the software instance to the software management module 204 via the network 231. In the succeeding step 109, the status information can be received and processed by the software management module. For example, the software management module may provide the status information to its analytical module 209 for executing a statistical evaluation of the usage frequency of various functionalities of the software. The service provider cloud 101 comprises a service-provider configuration module SPCM I. The service provider cloud 201 comprises a service-provider configuration module SPCM II stored on storage medium 251. The software management module 204 is operable to communicate with each of the SPCMs I, II via the network 231. In addition or alternatively to the execution of steps 106, 109, the steps 107, 108 may be executed. In step 107, the software management module 204 sends control data to the MAM of the at least one software instance for controlling the software Instance. In the succeeding step 108, the MAM of the software instance receives and processes the control data, whereby the received control data may affect the functionalities of the software instance provided to the at least one service consumer.

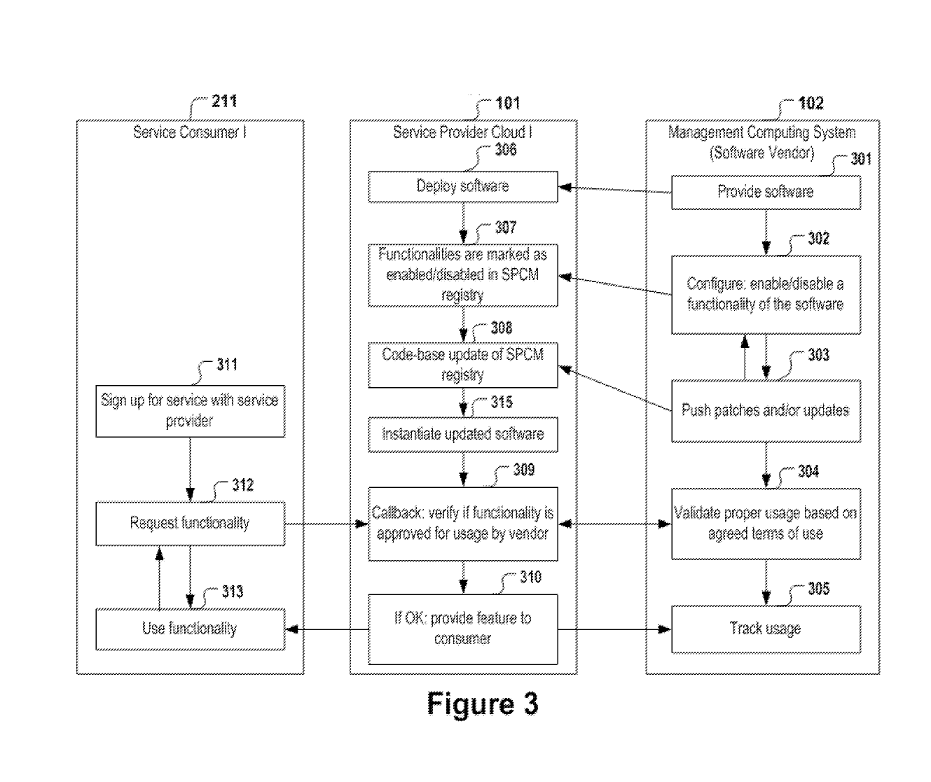

FIG. 3 is a flowchart of a method 300 for managing software, in accordance with another embodiment. The software can be managed at a software type level and/or at a software instance level. In describing the method 300, reference can be made to FIGS. 1 and 2.

In step 301, software created or otherwise provided by a vendor is provided from a management computing system 102 operated by the vendor to a service provider cloud 101 operated by a service provider. Step 301 can comprise hosting the software for download by the service provider on a website of the vendor or may comprise sending the software, e.g., on a CD-ROM to the service provider for installing that software on the service provider cloud 101. An identifier, binaries, and/or a configuration of the deployed software can be stored at the SPCM registry of the SPCM I of the service provider cloud 101. The software management module 204 installed on management computing system 102 enables the vendor to configure the software remotely, thereby enabling the vendor to enable and/or disable particular functionalities of the software having already been deployed in step 306 on the service provider cloud 101. For example, step 302 may be executed by the vendor via a graphical user interface provided by the software management module. The modifications introduced in step 302 to a configuration are automatically propagated via network 231 to one or more service provider clouds to which the software has already been deployed. The identity of the service provider clouds to receive the configuration specified in step 302 can be determined by the software management module 204 by means of its registry 207 wherein each software of the vendor is stored in association with IDs of one or more service provider clouds providing the software. As a result of having received a configuration changed in step 302 or right after deployment 306, the configuration is stored in a SPCM registry 501, shown in FIG. 5. The configuration comprises a specification of functionalities to be enabled or disabled. According to some embodiments, the software management module 204 is able to push software updates to the SPCM by replacing the binaries of the software (or parts thereof) by an updated version of the binaries (or parts thereof). The pushing step 303 updates the software on the software level and may be based on any communication standard, e.g. web services. Step 303 can alternatively precede step 302. In step 315, SPCM I instantiates a software, e.g., upon request of a service consumer, in accordance with the software's configuration stored in the SPCM registry. Typically, the changes introduced in step 302 are propagated automatically to the SPCM registry 501 in a push action. According to some implementations, at least some configuration changes may also received by the SPCM registry via a pull method.

When a functionality of a software instance is requested in step 312 by a service consumer, the corresponding software instance may execute in step 309 one or more callback methods, thereby communicating the requested functionalities to the software management module 204 via the MAM. A software instance may also execute a callback method automatically upon instantiation irrespective of the feature or function requested. The callback function may be part of the binary code or of an additional aspect of the software instance. Depending on the implementation, executing a callback function may comprise determining an identifier of the requested program feature or function and/or an identifier of the type of software instantiated. The determined identifier is forwarded to the MAM of the executed software instance and then forwarded to the software management module. Thus, the software management module 204 is enabled to check in step 304 whether the software is used in accordance with the license agreements stored in the registry 207. For example, it may be determined whether each actually used software instance was instantiated in accordance with the maximum number of software instances agreed upon for a particular service provider. If the software management module 204 determines in step 304 that the requested functionality is in accordance with the agreed terms of use, the software management module 204 will not disable the software or software instance and the service provider cloud provides the requested feature to the service consumer for usage in step 313. The functionalities provided to the consumer and actually used by the customer may be submitted as status information in step 310 to the software management module 204. The software management module 204 tracks this information in step 305 and may use this information for billing purposes and/or for metering the software usage by statistically evaluating the usage frequencies of the individual functions of the software or for pure analytics or planning purposes.

In case a deviation from the configuration, e.g., in respect to the enabled functions or the maximum allowed number of software instances or any other not allowed criteria was determined, the software management module 204 may disable the software on the software type level by re-executing step 302, thereby disabling the functionalities of the deployed software. In addition or alternatively, the software management module may also push inoperative binaries or code to the service provider by re-executing step 303 with appropriate binaries. In addition or as an alternative to the software type level updates and configuration steps, the MAM of each respective software instance can be used for executing an update on a per-instance basis or for enabling and/or disabling individual functionalities of already existing software instances at runtime. For executing an update at the software instance level, the software management module 204 sends an update to the individual software instances of the fraudulent service provider via the MAMs. The MAM of the software instance to be disabled receives the update, e.g. a new aspect written in AspectJ, and integrates the aspect into the already compiled byte code of the software instance at particular, predefined locations within the byte code or just applies a “traditional” update. For example, the MAMs may be implemented as web service clients while the software management module may comprise a web service interface for communicating with the respective MAM (and vice versa). For enabling or disabling individual functionalities of existing software instances, control data comprising an indication of the functionalities to be enabled or disabled is submitted to the individual software instances via their MAMs. According to embodiments, the request submitted upon execution of the callback method may in addition comprise an identifier of the user of the service consumer, and the registry 207 may have stored an identifier of the user in association with the terms of usage. Based on the determined identifier of the requested functionality and based on the assignment between a user ID and the terms of usage stored in the registry 207, the rules engine may automatically determine whether a particular user is allowed to use the requested functionality. For example, a user-ID may be received during the sign up step 311 when the user signs in at the service provider in order to consume a particular cloud service or software instance.

FIG.4 is an illustration of an overview of a system architecture 400 of a distributed computer system according to one further embodiment of the invention. A plurality of consumers, also referred to as ‘users’ 408-413, can use a processing device 211-213, 404-407, also referred to as ‘service consumer device’, for requesting and using software instances respectively provided by service provider clouds 101, 201 and 402 as cloud service. The service consumer devices, the service provider clouds and a super-cloud 403 running a software management module 204 are connected to each other via network 231.

FIG. 5 depicts service provider cloud 101 in greater detail. The SPCM I comprises a SPCM registry 501. The SPCM-registry comprises a list of each software instance which is or can be provided by the cloud to the service consumers. The list is indicated by the column ‘software ID’. The SPCM-registry may also include the binaries, a description and a configuration for each software in the list which is indicated by the column ‘software binaries’. The SPCM is responsible for instantiating the software contained in the SPCM registry, e.g. upon a request of a service consumer. When instantiating a particular software, the SPCM evaluates the configuration stored in association with the software for enabling and/or disabling functionalities of the software in accordance with the configuration. The instantiation may be executed based on binaries stored to the SPCM registry or based on binaries dynamically retrieved e.g. from the management computing system or another computing system of the vendor. As the software management module 204 of the vendor is operable to modify the configuration stored in the SPCM registry, the vendor is enabled to control the configuration of the software provided by a particular service provider on the software level. The software management module may communicate with the SPCM I via web services, remote procedure calls or other any other communication standard adapted for modifying a configuration.

1. A computer-implemented method, comprising:
providing at least one service provider cloud, the at least one service provider cloud providing an operating environment for one or more software instances;
establishing a communication between the one or more software instances and a management agent module at the at least one service provider cloud;
providing a software instance of the one or more software instances as a cloud service to at least one processing device constructed and arranged as a service consumer device;
managing, by a software management module, the software instance, wherein the software management module comprises a registry;
sending, from the management agent module to the software management module via a network, status information of the software instance to the software management module;
sending, from the software management module to the management agent module, control information;
processing, by the management agent module, the control data, permitting the software management module to control the software instance.

2. The computer-implemented method of claim 1, wherein the registry comprises data identifying the one or more software instances.

3. The computer-implemented method of claim 2, wherein the software management module manages the software instance of the one or more software instances indicated by the data in the registry.

4. The computer-implemented method of claim 1, wherein the at least one service consumer device uses the software instance provided by the at least one service provider cloud according to an Anything as a Service (XaaS) model.

5. The computer-implemented method of claim 1, wherein the at least one service provider cloud includes a plurality of interconnected computing resources.

6. The computer-implemented method of claim 1, wherein the status information includes data related to at least one of requests and uses of the software instance by the at least one service consumer device of the software instance.

7. The computer-implemented method of claim 1, wherein the control data establishes at least one of permitted uses and permitted functions of the software instance provided to the at least one service consumer device.

8. The computer implemented method of claim 1, wherein the one software instance executes one or more callback functions, each callback function executed at least one of:
1) in response to the software instance being requested by at least one service consumer device,
2) in response to a particular function of the software instance being called; and 3) in response to a usage of software instance being terminated.

9. The computer-implemented method of claim 8, further comprising:
executing, the software management module, one or more remote access functions, comprising:
executing, by the software instance, a callback function of the one or more callback functions; and
automatically submitting, by the executed callback function, a request for execution of a remote access function of the one or more remote access functions, the request submitted to the software management module, the receipt of the request by the software management module triggering the execution of the requested remote access function.

10. The computer-implemented method of claim 9, wherein each of the one or more remote access functions is selected from the group comprising:
at least one of activating and deactivating a functionality of a software instance of the one or more software instances having submitted the request;
at least one of activating and deactivating a functionality of the software instance;
executing a software-based update step, thereby deploying at least one of a software patch and an update for the software instance;
executing a software instance-based update step, thereby updating the software instance having submitted the request; and
analyzing, by the software management module, at least one of data submitted in the request and having been submitted in a set of previous requests.

11. The computer-implemented method of claim 1, wherein the management computing system is not one of the service provider clouds at least one of monitors and controls the one or more software instances running at the at least one service provider cloud, wherein the management computing system is at a different cloud than the at least one service provider cloud.

12. The computer-implemented method of claim 1, wherein the software management module is operable to at least one of enable and disable functionalities of the at least one software instance on a per-software basis and/or on a per-software-instance basis.

13. The computer-implemented method of claim 1, further comprising: at least one of enabling and disabling of functionalities by the software management module, wherein the at least one of enabling and disabling the functionalities includes at least one of:
identifying, by the registry, one or more service provider clouds of the at least one service provider cloud providing the software;
identifying one or more management agent modules being operatively coupled to software instances of the one or more software running at the at least one service provider cloud;
determining one or more functionalities of the software instances for enabling or disabling; and
sending an indication of the determined functionalities to the one or more identified management agent modules.

14. The computer-implemented method of claim 13, wherein the indication is one form of the control data, and wherein the identified one or more management agent modules at least one of enables and disables the indicated functionalities of operatively coupled software instances of the one or more software instances.

15. The computer-implemented method of claim 14, wherein at least one of enabling and disabling functionalities of the software instance of the one or more software instances on a per-software basis comprises: executing by the software management module at least one of:
identifying, by the registry, one or more service provider clouds of the at least one service provider cloud providing the software instance;
determining one or more functionalities of the software instance for enabling or disabling; and
transferring a configuration of the software instance to a service provider configuration module (SPCM) of the identified service provider clouds, the configuration comprising an indication of the determined functionalities to be at least one of enabled and disabled, wherein:
the service provider configuration module of each of the identified service provider clouds instantiates the software in accordance with the configuration specifying the functionalities to be enabled and disabled.

16. The computer-implemented method of claim 1, wherein each of the service provider clouds operates a service provider configuration module, and wherein, executing, by the software management module, further comprises:
providing, to the service provider configuration module of the at least one service provider cloud, a configuration for software including the one or more software instances provided by the service provider cloud, the software management module comprising a copy of the configuration or having remote access to the configuration, the configuration comprising one or more constraints;
evaluating status information received from one or more management agent modules operatively coupled to any of the one or more one software instances running at the at least one service provider cloud;
in response to the evaluation returned as a result the received status information violating one or more of the constraints of the configuration, executing at least one of the following:
at least one of enabling and disabling functionalities of the software on a per-software basis; and
at least one of enabling and disabling functionalities of the software on a per-software-instance basis; and
triggering the redirection of the at least one service consumer device to another service provider cloud of the at least one service provider cloud, wherein:
the one or more constraints comprises a threshold value being indicative of the maximum admissible number of the instances of the software provided by the service provider cloud and the evaluation comprises determining the number of software instances of the software currently running on the at least one service provider cloud.

17. The computer-implemented method of claim 1, wherein executable code specifying the new software function is received by the management agent module operatively coupled to the at least one software instance from an update module at the management computing system, and wherein the received executable code is injected or installed into the at least one software instance for at least one of adding, modifying, invoking, enabling and blocking one or more functionalities of the software instance.

18. A cloud service system, comprising:
at least one service provider cloud that provides software to one or more service consumers, the at least one service provider cloud including a management agent module to which a software instance of the software running at the at least one service provider cloud is in communication, the at least one service provider cloud including a plurality of interconnected computing devices; and
a management computing system in communication with the at least one service provider cloud via a network, the management computing system comprising a software management module that manages the software instance at the at least one service provider cloud, wherein:
the management agent module sends software instance status information to the software management module for processing by the software management module, the software management module sends control data to the management agent module in communication with the software instance, and the management agent module processes the control data, permitting the software management module to control the software instance.

19. The cloud service system of claim 18, wherein the software management module comprising a registry, the registry comprising an indication of the one or more software instances and an indication of the at least one service provider cloud respectively acting as a runtime environment, the software management module managing all software instances of the at least one service provider cloud indicated in the registry.

20. The cloud service system of claim 18, wherein the software management module comprises an update module, for executing at least one of a software-based update and a software instance-based update.

21. The cloud service system of claim 18, wherein the software management module comprises a rules engine, the rules engine being operable to:
evaluate one or more rules on the status information received from the management agent module operatively coupled to the at least one software instance and on the content of the registry, the content being indicative of a license agreement of a logged-in user and the at least one software instance, and to determine the control data in dependence on the received status information and the license information, and/or
evaluate one or more rules on the status information received from the management agent module operatively coupled to the at least one software instance and on the content of the registry, the content being indicative of the service provider cloud running the software instance, and to determine the control data in dependence on the received status information and the service provider cloud.

22. The cloud service system of claim 18, wherein the software management module comprises an analytical module that analyzes, the status information gathered by the management agent module in communication with the software instance, and statistically evaluating the functionalities of the software instance used by the one or more service consumers.

23. A computer program product of a service provider cloud, comprising:
a computer readable storage medium having computer readable program code embodied therewith, the computer readable program code comprising:
computer readable program code configured to provide one or more software instances operatively coupled to a management agent module;
computer readable program code configured to permit a management computing system to at least one of monitor and control the one or more software instances;
computer readable program code configured to provide the one or more software instances to service consumers according to an Anything as a Service (XaaS) model;
computer readable program code configured to send, from the management agent module to the software management module via a network, status information of a software instance of the one or more software instances to the software management module;
computer readable program code configured to receive, by the management agent module from the software management module, control information; and
computer readable program code configured to process, by the management agent module, the control data, permitting the software management module to control the software instance.

24. A computer program product of a management computing system in communication with a service provider cloud, comprising:
a computer readable storage medium having computer readable program code embodied therewith, the computer readable program code comprising:
computer readable program code configured to at least one of monitor and control one or more software instances running on at least one service provider cloud and being provided to service consumers according to the Anything as a Service (XaaS) model;
computer readable program code configured to connect the management computing system to the at least one service provider cloud via a network;
computer readable program code configured to provide a software management module for managing the one or more software instances, and for communicating, over the network, with a management agent module at the at least one service provide cloud in communication with the one or more software instances;
computer readable program code configured to provide a registry at the software management module, the registry comprising an indication of the one or more software instances and an indication of the at least one service provider cloud acting as a runtime environment, the software management module managing all software instances of the at least one service provider cloud indicated in the registry;
computer readable program code configured to receive status information sent from the management agent module in communication with a software instance of the one or more software instances, the status information being indicative of at least one of usage data and functionalities of the software instance used or requested by the at least one service consumer;
computer readable program code configured to monitor, at the software management module, the software instance of the one or more software instances; and
computer readable program code configured to send control data to the management agent module operatively coupled to the software instance of the one or more software instances for controlling the software instance, wherein the control data affects the functionalities of the software instance provided to the at least one service consumer.
